(19) United States
(12) Patent Application Publication
(10) Pub. No.: US 2024/0179448 A1
(43) Pub. Date: May 30, 2024

(54) SYSTEM AND METHOD FOR INTERACTIVE HEADPHONES

(71) Applicant: Charles Colbert, Stonecrest, GA (US)

(72) Inventor: Charles Colbert, Stonecrest, GA (US)

(21) Appl. No.: 18/385,497

(22) Filed: Oct. 31, 2023

Related U.S. Application Data
(63) Continuation of application No. 29/897,905, filed on Jul. 20, 2023.
Application No. 29/897,905 is a continuation of application No. 29/893,903, filed on Jun. 4, 2023, now Pat. No. D000415.
Application No. 29/893,903 is a division of application No. 29/861,073, filed on Nov. 25, 2022, now Pat. No. D988290.

(51) Int. Cl. H04R 1/10; A63H 33/28

(52) U.S. Cl. CPC H04R 1/1058; A63H 33/28; H04R 1/1008; H04R 1/1016; H04R 1/1041

(57) ABSTRACT

A system and method for an interactive three piece microphone with customizable features that may be quickly accessed by a user whereby the users' settings are automatically uploaded to the microphone providing a more personalized experience. The microphone may be used in a variety of situations where users may challenge one another as well as collect monetary rewards based on the location and type of performance they have.

### CROSS-REFERENCE TO RELATED APPLICATIONS

This application is a continuation of U.S. application Ser. No. 29/897,905, filed Jul. 20, 2023, which is a continuation of U.S. application Ser. No. 29/893,903 filed Jun. 4, 2023, and issued as U.S. Patent #D1,000,415 on Oct. 3, 2023, which is a Divisional of U.S. application Ser. No. 29/861,073 filed Nov. 25, 2022, and issued as U.S. Patent D988,290 on Jun. 6, 2023, all of which are hereby expressly incorporated by reference herein in their entirety.

### FIELD OF DISCLOSURE

The overall field of this invention is for audio electronics, and more particularly to audio headphones with various features and functionality to provide a unique experience for the user.

### BACKGROUND

As portable electronics become increasingly ubiquitous in society, the demand for personal audio headphones has witnessed a steady rise. Consequently, there has been a notable surge in the design and development of headphones to meet this growing demand. Manufacturers of headphones are constantly striving to create innovative designs and incorporate appealing features that resonate with consumers. One popular approach to enhance a product's appeal is by integrating aesthetic features into the headphone design but functionality is lacking in these features.

### SUMMARY

It is an object of the present invention to provide an interactive headphone system with various capabilities including temperature readings, display screens, camera footage, bubble blowing, and motors to move one or more objects up and down on the outside of the headphones.

### BRIEF DESCRIPTION OF DRAWINGS

The present invention will be described by way of exemplary embodiments, but not limitations, illustrated in the accompanying drawings in which like references denote similar elements, and in which:

FIG. 1 shows a block diagram of the various systems of the headphone of an exemplary interactive headphone system.

FIG. 2 shows an exemplary block diagram of a communication system of an interactive headphone system.

FIG. 3 shows an illustration of the exemplary headphone of an interactive headphone system.

FIG. 4 shows an illustration of the exemplary headphone of an interactive headphone system.

FIG. 5 shows an illustration of the exemplary headphone of an interactive headphone system.

FIG. 6 shows an exemplary block diagram of various components of a computing device.

FIG. 7 shows an illustration of another exemplary headphone of the interactive headphone system.

FIG. 8 shows an illustration of another exemplary headphone of the interactive headphone system.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following detailed description, numerous specific details are set forth in order to provide a more thorough understanding of the one or more embodiments described herein. However, it will be apparent to one of ordinary skills in the art that the invention may be practiced without these specific details. In other instances, well-known features have not been described in detail to avoid unnecessarily complicating the description.

The present disclosure recognizes the unsolved need for an improved system and method for an interactive headphone with customizable features that may be quickly accessed by a user through a display or user input buttons. The interactive headphone may be used in a variety of situations where users may blow bubbles, display video on a display screen, or control movement of ornamental objects that move up and down outside the headphones.

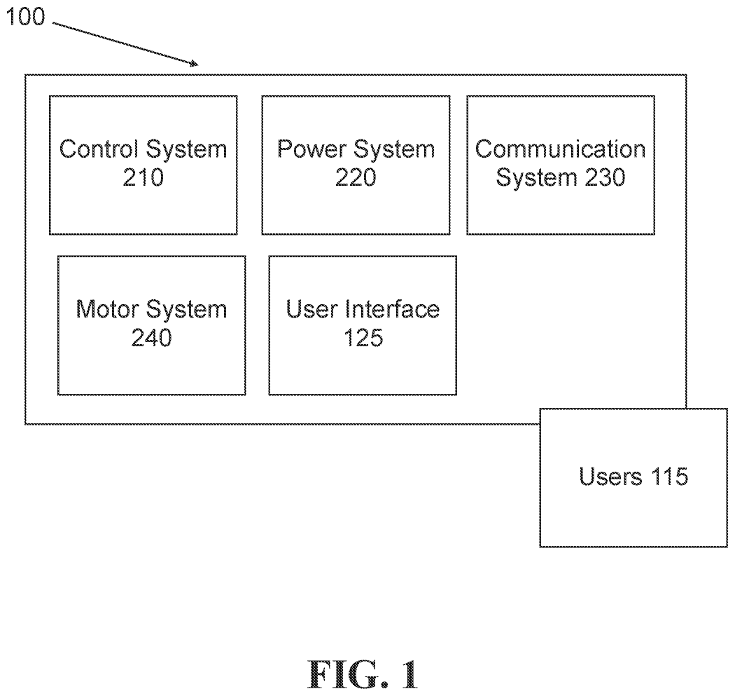

Turning to FIG. 1, FIG. 1 depicts a block diagram of an embodiment of the present invention for an interactive headphone system 100. Interactive headphone system 100 may be utilized by a series of users such as users 115. Further, interactive headphone system 100 may be located in various geographical locations that are either located apart or are located in proximity to each other.

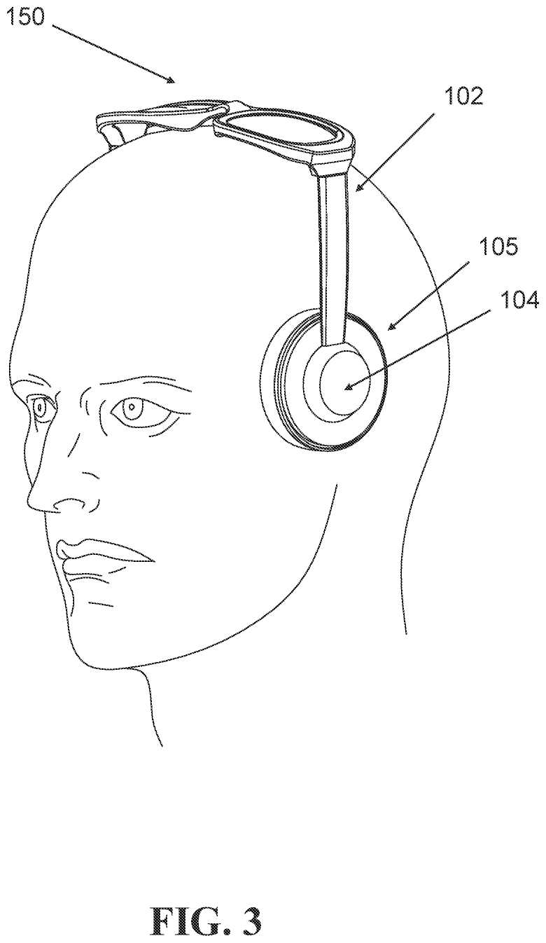

Interactive headphone system 100 may have a plurality of systems including a control system such as a control system 210, a power system 220, and a communication system 230, and a motor system 240 which may be integrated in combination within the structure of interactive headphone system 100. The various systems may be individually configured and correlated with respect to each other so as to attain the desired objective of providing an interactive headphone system 100. As illustrated in FIG. 3, interactive headphone system 100 may include a frame 102 that supports ear pieces 105 with speaker assemblies 104 positioned inside at opposite sides of frame 102. The outside of ear pieces 105 may also have one or more speakers to project sound to the surrounding environment. A headband may be positioned over frame 102 to provide comfort for the user and frames 102 may customizable or replaced with different objects. Speaker assemblies 104 may convert an electrical signal from control system 210 into an audible sound listened to by the user such as hearing aid. The speaker assemblies 104 may have noise cancellation or transparent features. In one or more embodiments any audio or video may be recorded in the one or more databases of control system or server for later playback or transmission to a separate device.

Ear pieces 105 may be traditional circular ear cups or ear buds or any type of ear pieces. Ear pieces 105 compact and lightweight and can be attached or detached from a connector interface on frame 102 whereby ear pieces will have a detachable outlet and may be connected wirelessly. Speaker assemblies 104 may come with their own built-in amplifiers and power source, ensuring self-sufficiency and minimal reliance on the headphone's power supply.

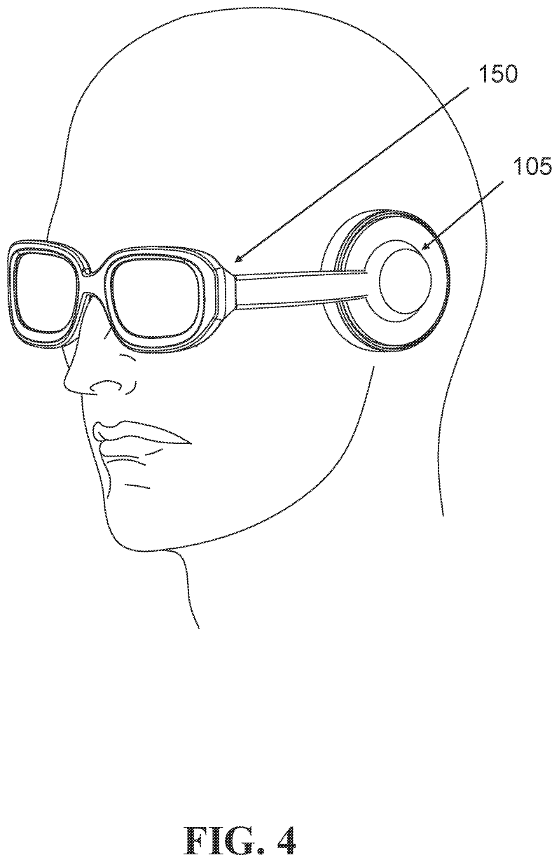

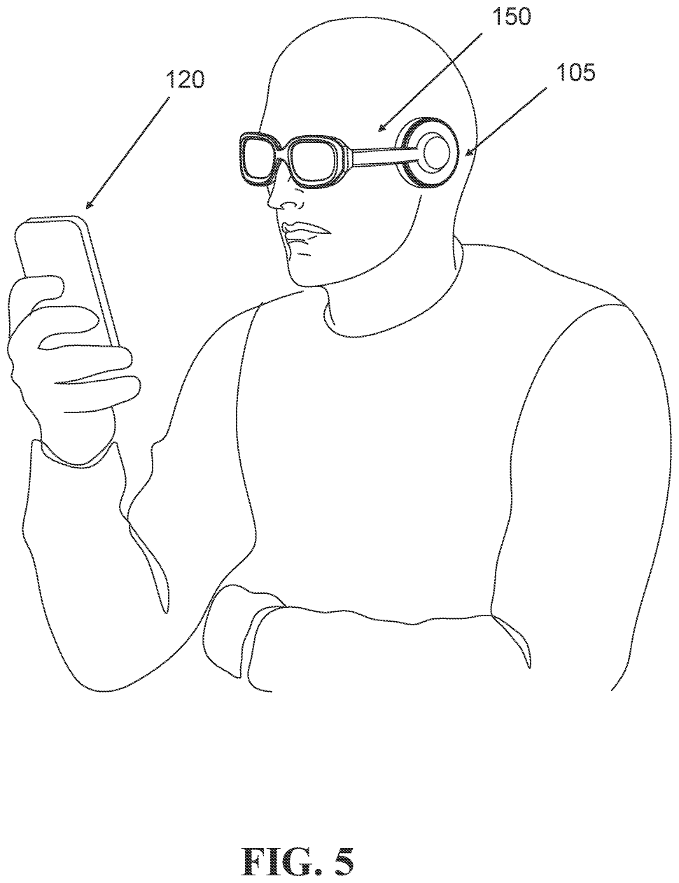

In one or more non-limiting embodiments, as illustrated in FIG. 3-5, the frame may take the form of sunglasses 150 that may be worn on the top of a user's 115 head, flipped down to cover their eyes, or removed completely. Sunglasses 150 may be connected to detachable outlets of ear pieces 105 and removed from the detachable outlets when needed.

Power system 220 of interactive headphone system 100 may provide the energy to interactive headphone system 100 including the circuits and components of control system 210 during operation of interactive headphone system 100. Interactive headphone system 100 may be powered by methods known by those of ordinary skill in the art. In some embodiments, power system 220 may include a rechargeable battery pack whereby the rechargeable battery is of a charge, design, and capacity, to provide sufficient power to interactive headphone system 100 and the circuits and components of control system 210 while interactive headphone system 100 is running for a set period of time.

Power system 220 may have a solar energy collector for collecting and converting solar energy to electrical energy. The solar generated electrical energy then passes through a first controller for distributing the electrical energy. The electrical energy may be stored in a battery; however, it may be used immediately to create a potential energy difference. The battery may hold an electrical-chemical potential sufficient to power the various components of interactive headphone system 100 for a predetermined amount of time. Power system 220 may have a solar energy collector for collecting and converting solar energy to electrical energy. The solar generated electrical energy then passes through a first controller for distributing the electrical energy. The electrical energy may be stored in a battery; however, it may be used immediately to create a potential energy difference. The battery may hold an electrical-chemical potential sufficient to power the various components of interactive headphone system 100 for a predetermined amount of time. The battery may also be used to charge one or more electronic devices through a charging adapter.

Control system 210 may operate to control the actuation of the other systems. Control system 210 may have a series of user computing devices which will be discussed in detail later in the description. Control system 210 may be in the form of a circuit board, a memory or other non-transient storage medium in which computer-readable coded instructions are stored, and one or more processors configured to execute the instructions stored in the memory. Control system 210 may have a wireless transmitter, a wireless receiver, and a related computer process executing on the processors.

User computing devices of control system 210 may be any type of user computing device that typically operates under the control of one or more operating systems which control scheduling of tasks and access to system resources. The user computing devices may be a phone, tablet, television, desktop computer, laptop computer, gaming system, wearable device electronic glasses, networked router, networked switch, networked, bridge, or any user computing device capable of executing instructions with sufficient processor power and memory capacity to perform operations of control system 210.

The one or more user computing devices may be integrated directly into control system 210, while in other non-limiting embodiments, control system 210 may be a remotely located user computing device or server configured to communicate with one or more other control systems 210 in interactive headphone system 100. Control system 210 may also include an internet connection, network connection, and/or other wired or wireless means of communication (e.g., LAN, etc.) to interact with other components. These connections allow users 115 to update, control, send/retrieve information, monitor, or otherwise interact passively or actively with control system 210.

Control system 210 may include control circuitry and one or more microprocessors or controllers acting as a servo control mechanism capable of receiving input from various components of interactive headphone system 100 as well communication system 230, analyzing the input from the components and communication system 230, and generating an output signal to the various components and communication system 230. The microprocessors (not shown) may have on-board memory to control the power that is applied to the various components, power system 220, and communication system 230, in response to input signals from the users 115 and the various components of interactive headphone system 100.

Control system 210 may maintain one or more databases including a library of digitized auditory signals including songs for play on the microphone through the speaker, whereby the library may be changed or updated through communication by server 300. Control system 210 may also receive and store data constituting images (e.g., still and/or moving video and/or graphical images) that may be displayed on interactive headphone system 100.

Interactive headphone system 100 may include local wireless circuitry, which would enable short-range communication to another user computing device as well as Bluetooth sensors and NFC chips. The local wireless circuitry may communicate on any wireless protocol, such as infrared, Bluetooth, IEEE 802.11, or other local wireless communication protocol.

Interactive headphone system 100 may have one or more communication ports coupled to the circuitry to enable a wired communication link to another device, such as but not limited to another wireless communications device including a laptop or desktop computer, television, video console, speaker, smart speaker, or voice assistant such as Alexa Echo®. The communication link may enable communication between Interactive headphone system 100 and other devices by way of any wired communication protocol, such as USB wired protocol, RS-232, or some proprietary protocol. Interactive headphone system 100 may have a global positioning system (GPS) unit coupled to the circuitry to provide location information to the circuitry whereby the GPS may provide the location information related to the location of interactive headphone system 100 as known by those of ordinary skill in the art.

Interactive headphone system 100 may communicate with other devices via communication links, such as USB (Universal Serial Bus) or HDMI/VGA (High-Definition Multimedia Interface/Video Graphics Array). Interactive headphone system 100 may include voice recognition capable software that may be used to navigate or issue instructions as well as fingerprint recognition software, optical scanners, optical pointers, digital image capture devices, and associated interpretation software. Interactive headphone system 100 may utilize additional Input Devices 265 and Other I/O 275 in the form of examples such as a speaker, smart speaker, microphone, headphone jack, indicator lights, and vibrational motor.

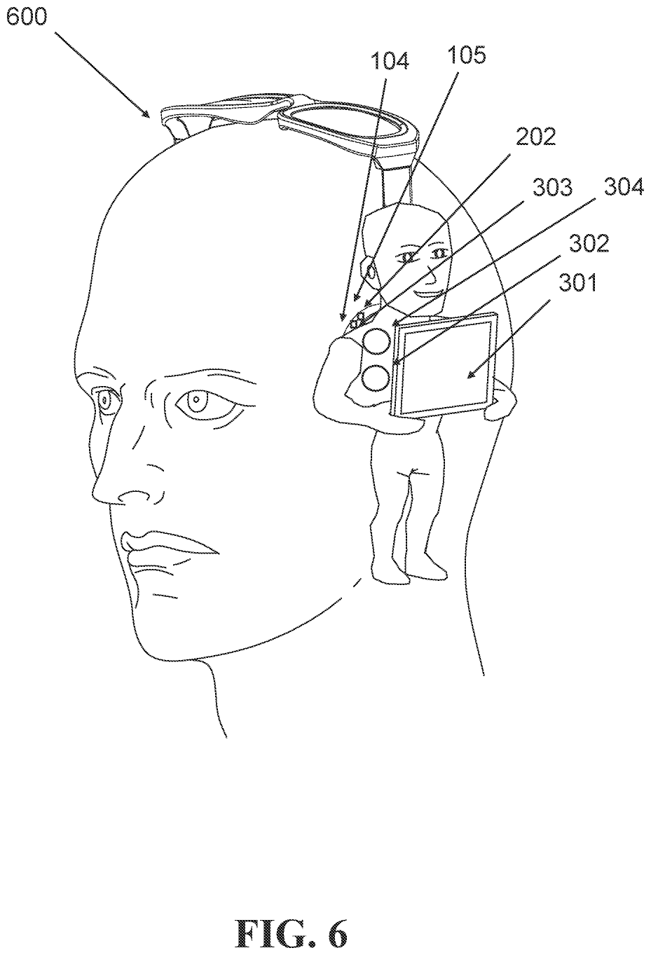

FIG. 6 shows a perspective view of interactive headphone system 600 according to one embodiment of the present invention. Interactive headphone system 100 may have a display screen 301 which may be displayed as a television held by a character or integrated into an object or apparatus or displayed in any way that would be appreciated by one of ordinary skill in the art, a set of user input buttons 302, a microphone 303, and one or more cameras 304, as well as similar components to the embodiments in FIG. 3. In this example embodiment, display screen 301 is a touchscreen display screen connected to control system 210 and operative to display visual contents in the form of both still images and/or video. Display screen 301 is further operative to receive user inputs via touch instructions. The contents displayed by display screen 301 may be predetermined content (e.g., music video, picture, etc.) and/or content generated in real-time via touch instructions. One or more display screens 301 may also be featured on the inside or outside of the sunglasses for visualization by the user or surrounding people.

User input buttons 302 may be mechanical devices connected to control system 210 for inputting user control commands directly into headphone system 100. User input buttons 302 may be positioned along the exterior of Interactive headphone system 100. User input buttons 302 may be utilized as a power button, volume up and volume down buttons for increasing and decreasing the volume of the audio output, a home button and directional keys to navigate through one or more menus. These locations are merely for illustrative purposes and interactive headphone system 100 may feature a power control, volume control, and home control button, on the front, back, and/or side of any components of interactive headphone system 100. In some embodiments, the sides of interactive headphone system 100 may have no buttons.

Cameras 304 may be positioned on the rear or sides or front or at any orientation or angle with respect to any part of the interactive headphone system 100 including the frame or headband. Cameras 304 have one or more lenses, one or more sensors, a photosensitive device, and one or more LED flashing lights or moving lights or any lightstream whereby images and video may be captured. For example, cameras 304 may capture pictures or video from a 360-degree field of view which may then be received by control system 210 and transmitted to display 301 or communication system 230. Cameras 304 may utilize sensors such as a charged-coupled device (CCD) or Complementary Metal-Oxide Semiconductor (CMOS) to sense a captured scene. The sensors in the camera may capture light reflected from the scene taken and translate the strength of that light into a numeric reading by passing light through a number of different color filters whereby the readings are combined and evaluated via software to determine the specific color of each segment of the picture.

In one or more embodiments one or more sensors 202 may be mounted on components of interactive headphone system 100. Sensor data may be received by one or more computing devices or remotely be received by a server, whereby sensor data is analyzed and the corresponding action or event is determined in response. Sensors 202 may be any type of sensor or combinations thereof. Examples of sensors 202 may include temperature sensors, pressure sensors, GPS, Local Positioning System (LPS), altimeters, which can identify where the user is located in a space, motion sensors (e.g., accelerometers or pedometers), which can generate data associated with the orientation of interactive headphone system 100 or if interactive headphone system 100 is moving in a specific direction. Other types of sensors may include biometric sensors that can sense the user's heart rate, temperature, brain wave activity, perspiration or other biometric sensors.

Interactive headphone system 100 or may have a light source (e.g., a light emitting diode (“LED”)) on interactive headphone system 100 or such as along the perimeter of ear pieces 105. The light source may light up or flash colors when certain events occur such as if the user is receiving an alert. In other embodiments, interactive headphone system 100 or may have a speaker assembly that produces an audible sound when events such as to notify and alert users and a microphone assembly to transmit audible sound to other users. The microphone assembly may be used to amplify sound towards the ears of the user through the speaker system.

Control system 210 may be in communication with communication system 230, as illustrated in FIG. 3 to connect with other user computing devices whereby signals transmitted from the user computing devices may be received by control system 210. Communication system 230 may allow users 115 to interact with control system 210 using a user computing device such as user computing devices 120 such as a phone to send or stream images and video to the display screen as well as talk to other people through the headphone. Users 115 may access a user interface, such as user interface 125 using user computing devices 120. User interface 125 may have a plurality of buttons or icons that are selectable by user 115 for communication system 230 to perform particular processes in response to the selections. User interface 125 may have conventional GUI interface devices such as a title bar, toolbars, pull-down menus, tabs, scroll bars, context help, dialog boxes, operating buttons (icons) and status bar that enable user navigation throughout the display.

In one or more non-limiting embodiments, communication system 230 may be innate, built into, or otherwise integrated into existing platforms or systems such as a website, a third party program, Apple™ operating systems (e.g., iOS), Android™, Snapchat™, Instagram™, Facebook™, or any other platform.

User computing device 120 of communication system 230 may be similar to the user computing devices of control system 210 and may be any type of user computing device that typically operates under the control of one or more operating systems which control scheduling of tasks and access to system resources. User computing device 120, may in some embodiments, be a user computing device such as an iPhone™, Android-based phone, or Windows-based phone, a tablet, television, desktop computer, laptop computer, gaming system, wearable device electronic glasses, networked router, networked switch, networked, bridge, or any user computing device capable of executing instructions with sufficient processor power and memory capacity to perform operations of interactive headphone system 100 while in communication with network 400. User computing device 120 may have location tracking capabilities such as Mobile Location Determination System (MLDS) or Global Positioning System (GPS) whereby they may include one or more satellite radios capable of determining the geographical location of user computing device 120.

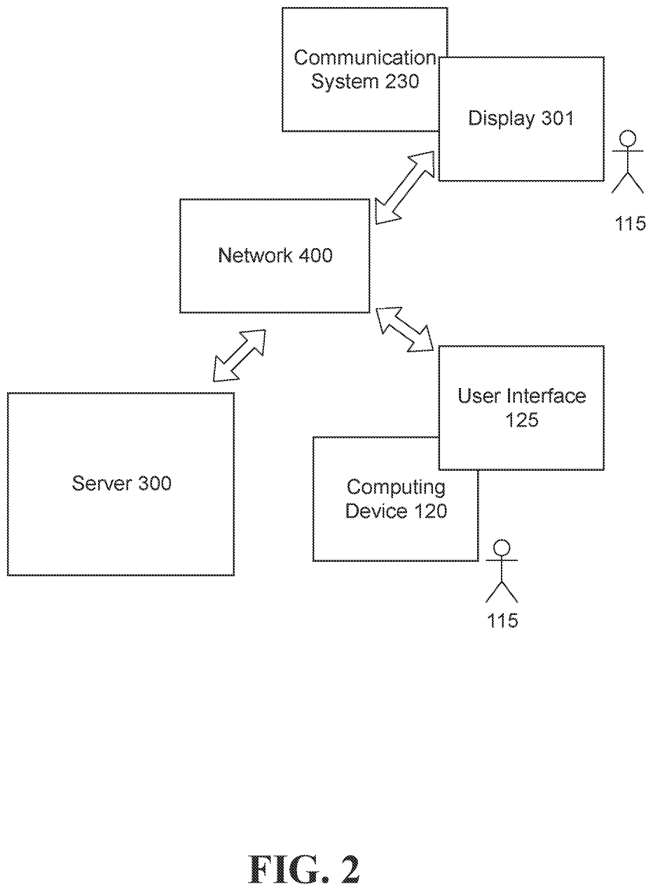

In some embodiments, user computing devices 120 may be in communication with one or more servers, such as server 300 via communication system 230 or one or more networks such as network 400 connected to communication system 230 as illustrated in FIG. 2. Server 300 may be located at a data center, or any other location suitable for providing service to network 400 whereby server 300 may be in one central location or in many different locations in multiple arrangements. Server 300 may comprise a database server such as MySQL® or Maria DB® server. Server 300 may have an attached data storage system storing software applications and data. Server 300 may have a number of modules that provide various functions related to communication system 230. Modules may be in the form of software or computer programs that interact with the operating system of server 300 whereby data collected in databases as instruction-based expressions of components and/or processes under communication system 230 may be processed by one or more processors within server 300 or another component of communication system 230 as well as in conjunction with execution of one or more other computer programs. Modules may be configured to receive commands or requests from user computing devices 120, server 300, and outside connected devices over network 400. Server 300 may comprise components, subsystems and modules to support one or more management services for communication system 230.

In one or more non-limiting embodiments, network 400 may include a local area network (LAN), such as a company Intranet, a metropolitan area network (MAN), or a wide area network (WAN), such as the Internet or World Wide Web. Network 400 may be a private network or a public network, or a combination thereof. Network 400 may be any type of network known in the art, including telecommunications network, a wireless network (including Wi-Fi), and a wireline network. Network 400 may include mobile telephone networks utilizing any protocol or protocols used to communicate among mobile digital user computing devices (e.g., user computing device 120), such as GSM, GPRS, UMTS, AMPS, TDMA, or CDMA. In one or more non-limiting embodiments, different types of data may be transmitted via network 400 via different protocols. In alternative embodiments, user computing devices 120, may act as standalone devices or whereby they may operate as peer machines in a peer-to-peer (or distributed) network environment.

Network 400 may further include a system of terminals, gateways, and routers. Network may employ one or more cellular access technologies including 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between user computing devices if for instance they are in a remote location not accessible by other networks.

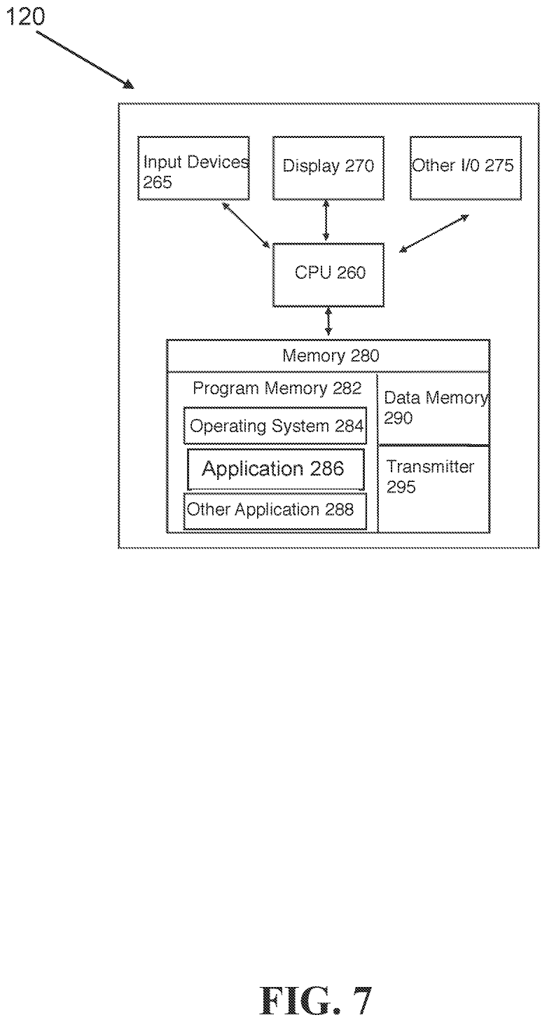

Turning to FIG. 7, FIG. 7 is a block diagram showing various components of user computing device 120. User computing device 120 may include a housing for containing one or more hardware components that allow access to edit and query communication system 230. User computing device 120 may include one or more input devices such as input devices 265 that provide input to a CPU (processor) such as CPU 260 of actions related to user 115. Input devices 265 may be implemented as a keyboard, a touchscreen, a mouse, via voice activation, wearable input device, a camera, a trackball, a microphone, a fingerprint reader, an infrared port, a controller, a remote control, a fax machine, and combinations thereof.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen, an LED display screen, a projected, holographic, virtual reality display, or augmented reality display (such as a heads-up display device or a head-mounted device), wearable device electronic glasses, contact lenses capable of computer-generated sensory input and displaying data, and so on. Display 270 may also comprise a touch screen interface operable to detect and receive touch input such as a tap or a swiping gesture. Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programing interface (API), such as API 286, and other computerized programs or application programs such as application programs 288. Memory 280 may also include data memory such as data memory 290 that may include database query results, configuration data, settings, user options, user preferences, or other types of data, which may be provided to program memory 282 or any element of user computing device 120.

User computing device 120 may have a transmitter 295, such as transmitter 295, to transmit the biological data. Transmitter 295 may have a wired or wireless connection and may comprise a multi-band cellular transmitter to connect to the server 300 over 2G/3G/4G cellular networks. Other embodiments may also utilize Near Field Communication (NFC), Bluetooth, or another method to communicate information.

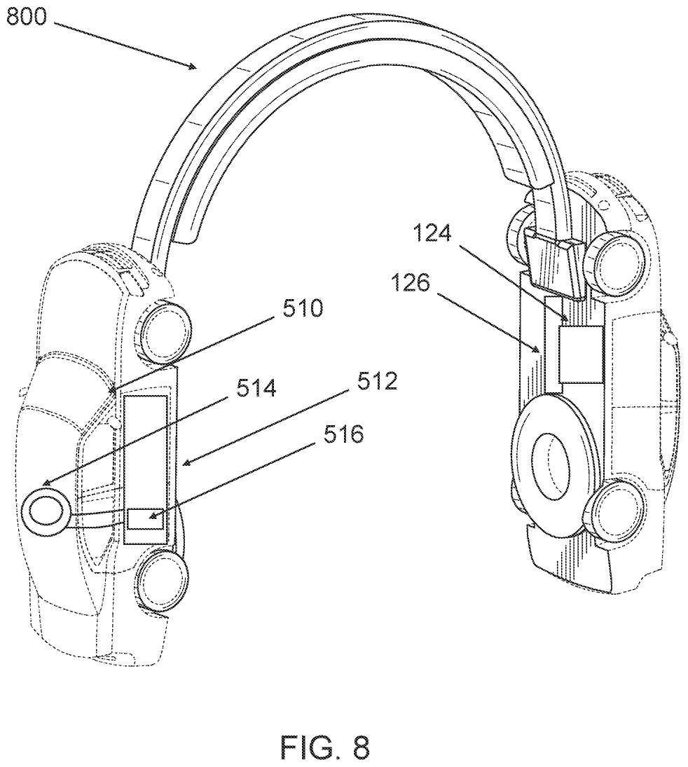

In one or more non-limiting embodiments interactive headphone system 800 may have a bubble blowing system 510 designed to produce and release soap bubbles from its body, providing an entertaining and interactive experience for users 115, as illustrated in FIG. 8. The mechanism utilizes a combination of air pressure and liquid soap solution to create a stream of bubbles from a bubble solution composition at different points of interactive headphone system 100. The bubble solution composition may include water, soap, glycerin, and other suitable additives to optimize bubble formation and longevity

Bubble blowing system 510 may include a bubble solution reservoir 512, a bubble wand 514, and an air pump 516. Bubble solution reservoir 512 may store the soap bubble solution in any parts of the headphone including the ears cup or the frame or separate removable attachment. Bubble solution reservoir 512 may be accessible through a removable securely fastened compartment that allows for easy refilling. Bubble wand 514 may be positioned near an opening of the housing of ear pieces 105 or any other part of the headphones. Bubble wand 514 extends from bubble solution reservoir 512 to the exterior of ear pieces 105.

Air pump 516 may be mechanical or electronic and integrated into ear pieces 105. Air pump 516 may be connected to the bubble solution reservoir 512 and the bubble wand 514. When activated, air pump 516 generates a controlled airflow that propels the bubble solution from bubble solution reservoir 512 through the bubble wand 514.

Interactive headphone system 100 may include an activation mechanism to initiate the bubble-blowing process. The activation mechanism can take various forms, such as a push-button, a switch, or a sensor on user input buttons 302 or by voice command. When the user activates the mechanism, air pump 516 begins to operate, pushing the bubble solution through the bubble wand 514, resulting in a steady stream of bubbles from housing 101.

In one or more non limiting embodiments ear pieces 105 may have one or more motors 124. Motors 124 may be an electric motor, which can be an AC motor, a DC motor, or any suitable motor type known in the art. Motors 124 may be connected to any number of gears, pulleys, belts, to convert the rotational motion of motors 124 into a vertical linear shaft 126. In some embodiments shaft 126 may move in a horizontal movement as well as diagonal movement. Shaft 126 may extend through an exterior of ear pieces 105 and connected to a removable or permanently installed ornamental object which may have a sliding engagement with the ear pieces 105 such that the ornamental object may move in different directions. The ornamental object may be any number of objects such as but not limited to a shoe, boot, or any footwear with a sole, a car, truck, bus, or any transportation with wheels or no wheels, an airplane or rocket, a human with a head 2 arms 2 legs with feet and body or another configuration for any known human, or an animal with 4 legs with feet and a body and with or without a tail or any other configuration for any known animal. It should be understood that each headphone may be customizable and have multiple moving parts whereby a series of motors may be used to control different parties of the ornamental object such as individual hands and legs or wheels and these components may be a part of the earcups and wirelessly detached or attach onto ear pieces 105.

Motors 124 may be connected to control system 210 and be controlled by a variety of controls and settings. For example, the user may be able to adjust the intensity and frequency of the squeezing motion using user input buttons 302.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. An interactive headphone system, comprising:
headphones with a first ear piece coupled to a frame, wherein the first ear piece includes a speaker, and a second ear piece coupled to the frame, wherein the second ear piece includes a second speaker.

2. The interactive headphone system of claim 1, further comprising:
a display screen positioned on each of the first ear piece and the second ear piece.

3. The interactive headphone system of claim 2, further comprising:
a temperature sensor connected to a control system that presents the temperature on the display screen.

4. The interactive headphone system of claim 1, further comprising:
one or more motors in the first ear piece and the second ear piece.

5. The interactive headphone system of claim 4, further comprising:
a shaft connected to the one or more motors.

6. The interactive headphone system of claim 5, wherein the shaft moves in a linear direction.

7. The interactive headphone system of claim 6, further comprising:
an ornamental object connected to the shaft and configured to move in unison with the shaft.

8. The interactive headphone system of claim 7, wherein the ornamental object is detachable from the headphones.

9. The interactive headphone system of claim 8, wherein the ornamental object is a shoe.

10. The interactive headphone system of claim 8, wherein the ornamental object is a human or animal body.

11. The interactive headphone system of claim 8, wherein the ornamental object is a car.

12. The interactive headphone system of claim 1, further comprising:
a bubble blowing system.

13. The interactive headphone system of claim 12, wherein the bubble blowing system includes a reservoir, a pump connected to the reservoir, and wand connected to the pump.

14. The interactive headphone system of claim 2, further comprising: cameras connected to a control system that presents footage on the display screen.

15. The interactive headphone system of claim 14, wherein the cameras are positioned at a rear and side of the headphones.

16. The interactive headphone system of claim 1, wherein the first ear piece and the second ear piece are detachable from the frame.

17. The interactive headphone system of claim 16, wherein the frame is in a form of sunglasses.

18. The interactive headphone system of claim 17, wherein the first ear piece and the second ear piece are ear pads.

19. The interactive headphone system of claim 17, wherein the first ear piece and the second ear piece are ear buds.
